(19) United States
(12) Patent Application Publication
(10) Pub. No.: US 2011/0268381 A1
(43) Pub. Date: Nov. 3, 2011

(54) ROLLING BEARING DEVICE

(75) Inventors: Kazuki HAMADA, Kashiwara-shi (JP); Hiroshi UENO, Tondabayashi-shi (JP); Isao USUKI, Yamatotakada-shi (JP)

(73) Assignee: JTEKT CORPORATION, Osaka (JP)

(21) Appl. No.: 13/092,511

(22) Filed: Apr. 22, 2011

(30) Foreign Application Priority Data
Apr. 28, 2010 (JP) 2010-103914

(51) Int. Cl. F16C 33/58

(52) U.S. Cl. 384/569

(57) ABSTRACT

A rolling bearing 10 includes an outer ring fixed to a housing, an inner ring that is arranged so as to face the outer ring in the radial direction of the rolling bearing and that is fixed to a rotating shaft, balls that are rollably arranged at positions between the outer ring and the inner ring in the radial direction, and seal members that seal up an annular space between the outer ring and the inner ring. Escape passages through which fluid is circulated in the axial direction of the rolling bearing so as to be allowed to escape are formed in a contact portion of the outer ring, which contacts the housing.

### INCORPORATION BY REFERENCE

The disclosure of Japanese Patent Application No. 2010-103914 filed on Apr. 28, 2010 including the specification, drawings and abstract is incorporated herein by reference in its entirety.

### BACKGROUND OF THE INVENTION

1. Field of the Invention

The invention relates to a rolling bearing device.

2. Description of Related Art

There is an existing rolling bearing that includes a plurality of rolling elements arranged between an inner ring and an outer ring. In the rolling bearing, grease is supplied in an annular space between the inner ring and the outer ring, and the annular space is sealed up with seal members to prevent leakage of the grease (refer to, for example, Japanese Patent Application Publication No. 2008-95753 (JP 2008-95753 A)). The radially-outer end portions of the seal members are fixed to the respective axial end portions of the outer ring. The seal members have sliding surfaces, which slide with respect to the inner ring, at the radially-inner end portions.

In the rolling bearing that includes contact-type seal members as described above, because sliding resistance is generated between the seal members and the inner ring, a rotational load increases. Therefore, using such a rolling bearing for devices that are required to rotate at high speed is not favorable. Accordingly, for the devices that are required to rotate at high speed, using non-contact-type seal members such as labyrinth seals instead of contact-type seal members is favorable.

However, under an environment where fluid such as gas or liquid flows around the rolling bearing, especially, under an environment where high-pressure fluid flows around the rolling bearing, there is a high possibility that the fluid enters the annular space between the inner ring and the outer ring through seal gaps between the seal members and the inner ring. Then, the grease present within the annular space may be washed away by the fluid that has entered the annular space. As a result, a decrease in the lubricating function may be accelerated. Therefore, some measures need to be taken to address this problem. Even in a case where contact-type seal members are used, it is preferable to provide the function of preventing fluid from entering gaps between the seal members and the inner ring as the overall rolling bearing, in addition to the sealing function of the seal members alone, under the environment where high-pressure fluid flows.

### SUMMARY OF THE INVENTION

It is an object of the invention to provide a rolling bearing device in which entrance of fluid into an annular space between a fixed bearing ring and a rotating bearing ring is suppressed even under an environment where fluid flows around a rolling bearing.

An aspect of the invention relates to a rolling bearing device, including: a fixed member; a fixed bearing ring that is fixed to the fixed member; a rotating bearing ring that is arranged so as to face the fixed bearing ring in a radial direction of the rolling bearing and that is fixed to a rotating member; a rolling element that is rollably arranged at a position between the fixed bearing ring and the rotating bearing ring in the radial direction; and a seal member that seals up an annular space between the fixed bearing ring and the rotating bearing ring. An escape passage through which fluid is circulated in an axial direction of the rolling bearing so as to be allowed to escape is formed in at least one of a contact portion of the fixed member and a contact portion of the fixed bearing ring, the fixed member and the fixed bearing ring contacting each other at the contact portions.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view schematically showing a rolling bearing device according to an embodiment of the invention;

FIG. 2 is a sectional view taken along the line II-II in FIG. 1;

FIG. 3 is a perspective view showing a rolling bearing;

FIG. 4 is a perspective view showing the rolling bearing cut along a plane that passes the axis of the rolling bearing;

FIG. 5 is a sectional view showing a rolling bearing according to a modified example (view corresponding to the sectional view taken along the line II-II in FIG. 1); and

FIG. 6 is a sectional view showing a rolling bearing according to another modified example (view corresponding to the sectional view taken along the line II-II in FIG. 1).

### DETAILED DESCRIPTION OF EMBODIMENTS

Hereafter, an embodiment of the invention will be described with reference to the accompanying drawings.

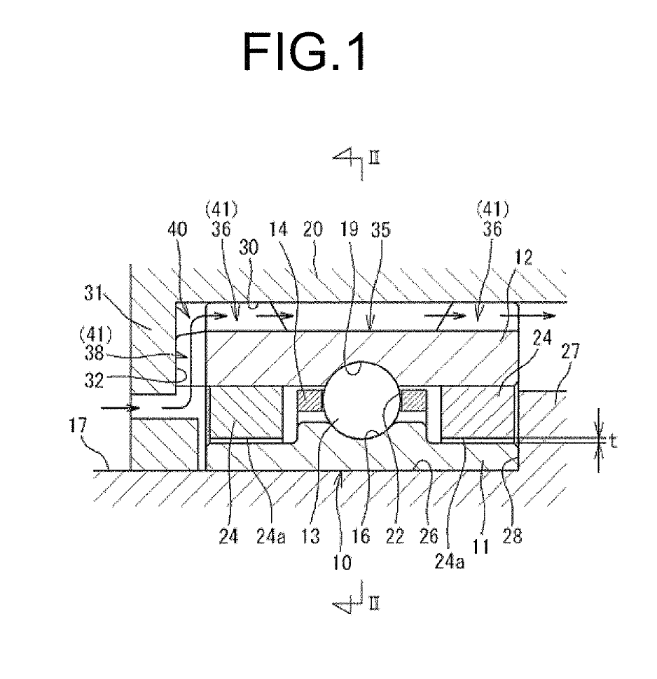

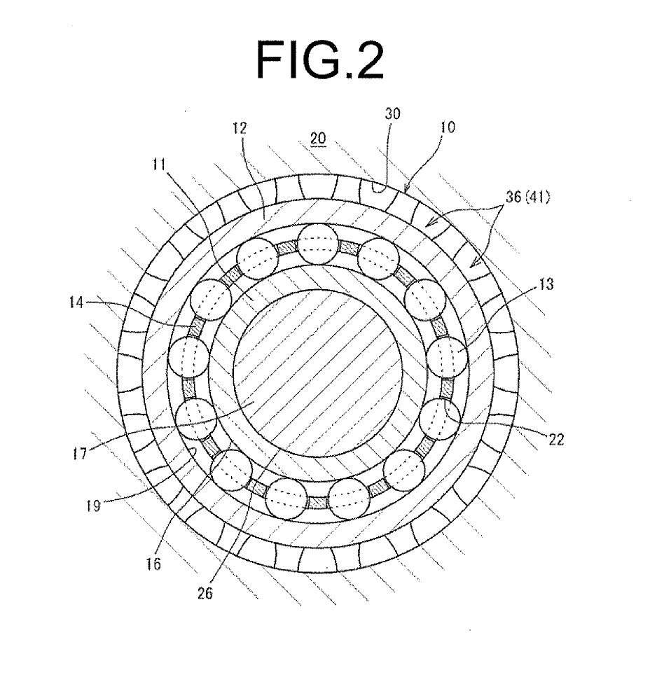

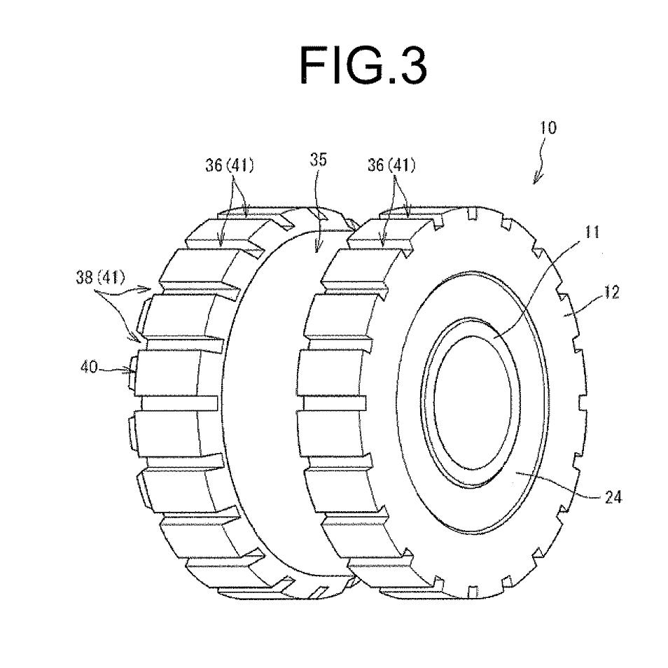

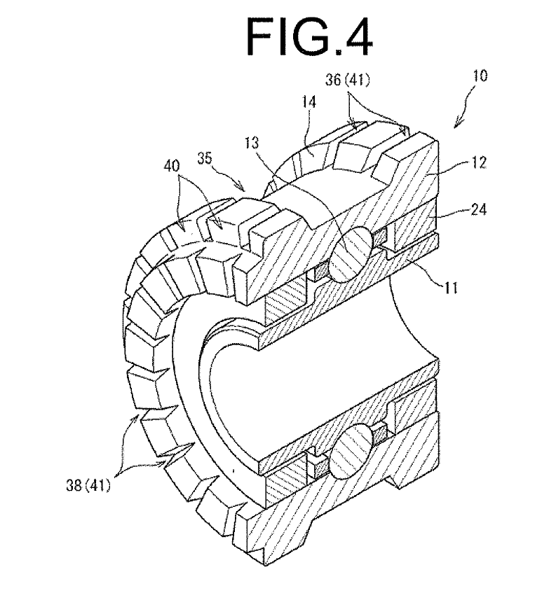

FIG. 1 is a sectional view schematically showing a rolling bearing device according to the embodiment of the invention. FIG. 2 is a sectional view taken along the line II-II in FIG. 1. FIG. 3 is a perspective view showing a rolling bearing 10. FIG. 4 is a perspective view showing the rolling bearing 10 cut along a plane that passes the axis of the rolling bearing 10. The rolling bearing device according to the embodiment includes the rolling bearing 10 fitted to a housing 20. The rolling bearing 10 is a ball bearing that includes an inner ring 11, an outer ring 12, balls 13 that are provided between the inner ring 11 and the outer ring 12 and that serve as rolling elements, and a retainer 14 that retains the balls 13.

The inner ring 11 is formed into an annular shape. A recessed inner ring raceway surface 16 is formed in substantially the axial center portion of the outer peripheral surface of the inner ring 11 so as to extend along the whole circumference of the outer peripheral surface. A rotating shaft (rotating member) 17 is fitted and fixed to the inner peripheral surface of the inner ring 11. As the rotating shaft 17 rotates, the inner ring 11 rotates together with the rotating shaft 17. Therefore, the inner ring 11 according to the embodiment may constitute a rotating bearing ring according to the invention.

The outer ring 12 as well as the inner ring 11 is formed into an annular shape. The outer ring 12 is arranged on the radially outer side of the inner ring 11 so as to be coaxial with the inner ring 11. A recessed outer ring raceway surface 19 is formed in substantially the axial center portion of the inner peripheral surface of the outer ring 12 so as to extend along the whole circumference of the inner peripheral surface. The outer ring 12 is fixed when the outer peripheral surface thereof is fitted to the housing (fixed member) 20. Therefore, the outer ring 12 in the embodiment may constitute a fixed bearing ring according to the invention.

The retainer 14 is an annular member made of synthetic resin, for example, phenol resin. The retainer 14 has a plurality of pockets 22 used to house the balls 13 and formed at regular intervals in the circumferential direction. The balls 13 are housed in the respective pockets 22 of the retainer 14 so as to be retained at predetermined intervals in the circumferential direction. The balls 13 roll at positions between the inner ring raceway surface 16 and the outer ring raceway surface 19.

Two annular seal members 24 are fitted to the inner peripheral surface of the outer ring 12. The seal members 24 are fixed to the outer ring 12 when the seal members 24 are fitted to the respective axial end portions of the inner peripheral surface of the outer ring 12. Inner peripheral surfaces 24a of the seal members 24 are cylindrical surfaces, and arranged at positions close to the respective axial end portions of the outer peripheral surface of the inner ring 11 with seal gaps t. The seal gaps t form seal gaps (labyrinth gaps). Lubricant, for example, grease is supplied in a space between the two seal members 24.

A large-diameter portion 27 is formed on the outer peripheral surface of the rotating shaft 17. The large-diameter portion 27 is larger in outer diameter than a portion (fitted portion 26) of the rotating shaft 17, to which the inner ring 11 is fitted. One axial end portion (right end portion) of the inner ring 11 contacts a step portion 28 that is formed between the fitted portion 26 and the large-diameter portion 27. Thus, movement of the inner ring 11 relative to the rotating shaft 17 toward one side (right side) in the axial direction is restricted.

The housing 20 has a small-diameter portion 31 that is smaller in inner diameter than a portion (fitted portion 30) of the housing 20, to which the outer ring 12 is fitted. The other axial end portion (left end portion) of the outer ring 12 contacts a step portion 32 that is formed between the fitted portion 30 and the small-diameter portion 31. Thus, movement of the outer ring 12 relative to the housing 20 toward the other side (left side) in the axial direction is restricted.

A recess 35 is formed in the axial center portion of the outer peripheral surface of the outer ring 12 so as to extend along the whole circumference of the outer ring 12. In addition, axial grooves 36 that extend in the axial direction are fowled in the respective axial end portions of the outer peripheral surface. Multiple axial grooves 36 are formed at intervals in the circumferential direction, as shown in FIGS. 2 to 4. The depth of each axial groove 36 is substantially equal to the depth of the recess 35, and sufficiently larger than the seal gap t formed between each seal member 24 and the outer peripheral surface of the inner ring 11.

Radial grooves 38 that extend in the radial direction are formed in an axial end portion (left end portion) of the outer ring 12, which contacts the step portion 32 of the housing 20. Multiple radial grooves 38 are formed at intervals in the circumferential direction, like the axial grooves 36. In the embodiment, the number of the axial grooves 36 is equal to the number of the radial grooves 38. The axial grooves 36 and the radial grooves 38 are formed at the same positions in the circumferential direction.

A circumferential groove (communication groove) 40 is formed at a boundary portion (corner portion) between the outer peripheral surface of the outer ring 12, in which the axial grooves 36 are formed, and the axial end surface of the outer ring 12, in which the radial grooves 38 are formed. The circumferential groove 40 is formed along the whole circumference of the outer ring 12. The circumferential groove 40 provides communication between all the axial grooves 36 and radial grooves 38.

As shown in FIG. 1, the above-described axial grooves 36 and radial grooves 38 form escape passages 41 through which the fluid that flows around the rolling bearing 10 is circulated. When high pressure fluid such as gas or liquid is present around the rolling bearing 10, if the axial grooves 36 and the radial grooves 38 are not formed, the fluid that has entered the housing 20 may enter the annular space within the rolling bearing 10 through the seal gaps t and wash away the grease within the rolling bearing 10. The early exhaustion of the grease may cause increases in the rotational load or reduce the durability.

In contrast, according to the embodiment, the axial grooves 36 and the radial grooves 38 are formed in the outer ring 12. Therefore, the fluid that has entered the housing 20 is circulated in the axial direction through the escape passages 41 formed of the axial grooves 36 and the radial grooves 38 as indicated by arrows in FIG. 1, and the fluid is allowed to escape so that the fluid does not enter the inside of the rolling bearing 10 through the seal gaps t. Accordingly, it is possible to appropriately keep grease within the rolling bearing 10, thereby maintaining the lubricating function.

The circumferential groove 40 is formed in the outer ring 12 to provide communication between the multiple radial grooves 38 and the multiple axial grooves 36. Accordingly, it is possible to more easily circulate the fluid.

In addition, the volume of the escape passages 41 is increased by the recess 35 formed in the axial center portion of the outer peripheral surface of the outer ring 12. Accordingly, it is possible to decrease the flow resistance of the fluid that flows through the axial grooves 36.

Note that the invention is not limited to the above-described embodiment, and may be modified as needed within the scope of the inventions described in claims.

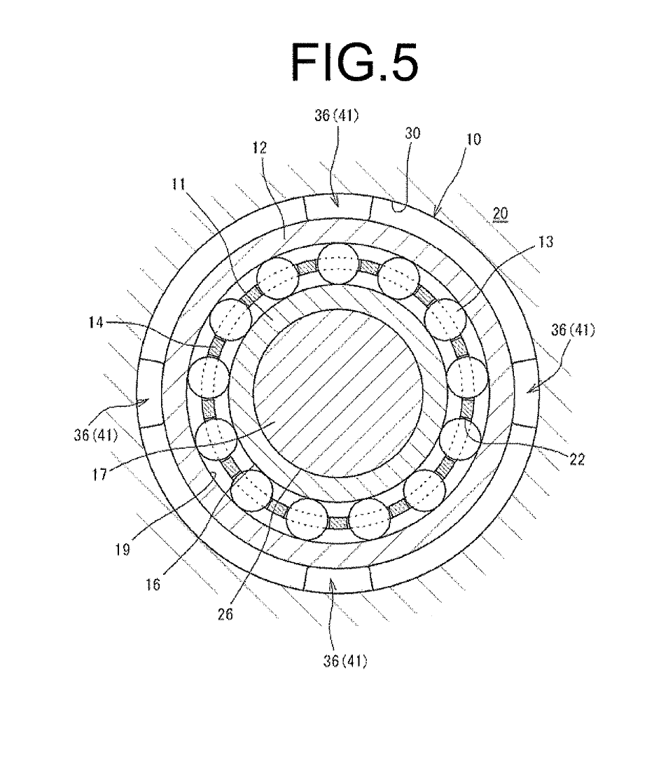

The number of the axial grooves 36 and radial grooves 38 (the number of escape passages 41) formed in the outer ring 12 is not particularly limited, and may be changed as needed. For example, in a modified example shown in FIG. 5, four axial grooves 36 are formed in the outer peripheral surface of the outer ring 12 at regular intervals (at intervals of 90 degrees). In this configuration as well, it is possible to allow the fluid present around the rolling bearing 10 to escape through the axial grooves 36, and to suppress entrance of the fluid present around the rolling bearing 10 into the annular space between the outer ring 12 and the inner ring 11. Although the radial grooves 38 and the circumferential groove 40 are not shown in FIG. 5, these grooves 38 and 40 may be formed in the outer ring 12 as in the above-described embodiment.

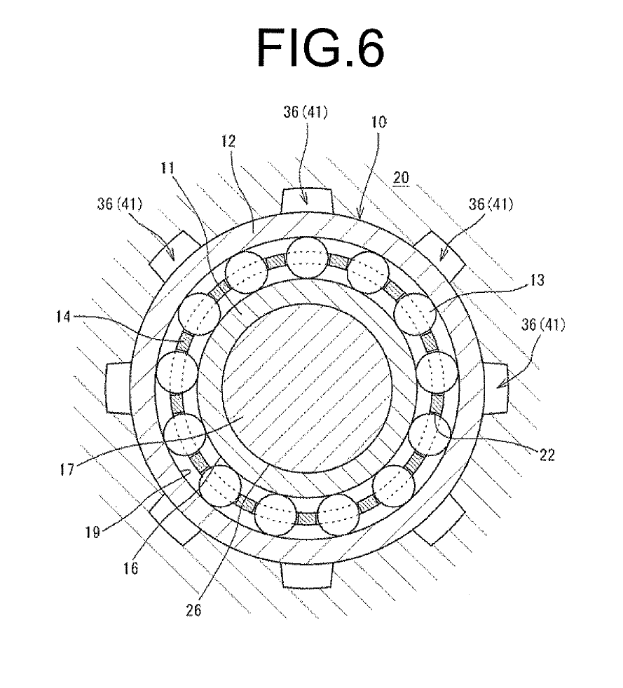

The axial grooves 36 and the radial grooves 38 (escape passages 41) may be formed in the housing 20, not in the outer ring 12. For example, in a modified example shown in FIG. 6, multiple axial grooves 36 (escape passages 41) are formed in the fitted portion 30, which is formed in the housing 20 and to which the outer ring 12 is fitted, at intervals in the circumferential direction. Accordingly, it is possible to allow the fluid present around the rolling bearing 10 to escape through the axial grooves 36, and to suppress entrance of the fluid present around the rolling bearing 10 into the annular space between the outer ring 12 and the inner ring 11. Although the radial grooves 38 and the circumferential groove 40 are not shown in FIG. 6, these grooves 38 and 40 may be formed in the housing 20.

The axial grooves 36 and the radial grooves 38 may be formed in both the outer ring 12 and the housing 20.

In the embodiment described above, the recess 35 is formed in the axial center portion of the outer peripheral surface of the outer ring 12. Alternatively, the recess 35 may be omitted and the axial grooves 36 may be formed so as to extend in the entire outer ring 12 in the axial direction. In addition, the circumferential grooves 30 may also be omitted.

When both axial end surfaces of the outer ring 12 of the rolling bearing 10 contact the housing 20, the radial grooves 38 may be formed in the both end surfaces. When neither of the axial end surfaces of the outer ring 12 contacts the housing 20, the radial grooves 38 may be omitted.

The seal members that seal up the annular space between the outer ring 12 and the inner ring 11 may be contact-type seal members.

In the embodiment described above, the outer ring 12 is used as the fixed bearing ring that is fixed to the housing (fixed member) 20, and the inner ring 11 is used as the rotating bearing ring fixed to the rotating shaft (rotating member) 17. Alternatively, the invention may be applied to a rolling bearing device in which the outer ring 12 is used as a rotating bearing ring fixed to a rotating member and the inner ring 11 is used as a fixed bearing ring fixed to a fixed member.

The invention may be applied to various bearings such as groove ball bearings that are different from the ball bearing in the embodiment described above, cylindrical roller bearings and tapered roller bearings.

With the configurations described above, when the rolling bearing device is used under the environment where the fluid flows around the rolling bearing, it is possible to suppress entrance of the fluid into the annular space between the fixed bearing ring and the rotating bearing ring, which is sealed up with the seal members, by allowing the fluid to escape through the escape passages. Accordingly, even if grease is supplied in the annular space, the grease is hardly washed away by the fluid. As a result, it is possible to suppress a decrease in the lubricating function.

The seal members are preferably non-contact-type seal members which are fixed to the fixed bearing ring and with which seal gaps are formed between the seal members and the rotating bearing ring. In this case, almost no sliding resistance is generated between the seal members and the rotating bearing ring. In addition, the situation hardly occurs where the fluid present around the rolling bearing enters the seal gaps between the seal members and the rotating bearing ring and the grease leaks through the seal gaps. Therefore, it is possible to appropriately maintain the lubricating function. Accordingly, the rolling bearing device according to the invention is appropriately used for a rotating device that rotates at high speed.

What is claimed is:

1. A rolling bearing device, comprising:
a fixed member;
a fixed bearing ring that is fixed to the fixed member;
a rotating bearing ring that is arranged so as to face the fixed bearing ring in a radial direction of the rolling bearing and that is fixed to a rotating member;
a rolling element that is rollably arranged at a position between the fixed bearing ring and the rotating bearing ring in the radial direction; and
a seal member that seals up an annular space between the fixed bearing ring and the rotating bearing ring,
wherein an escape passage through which fluid is circulated in an axial direction of the rolling bearing so as to be allowed to escape is formed in at least one of a contact portion of the fixed member and a contact portion of the fixed bearing ring, the fixed member and the fixed bearing ring contacting each other at the contact portions.

2. A rolling bearing device, comprising:
a fixed bearing ring that is fixed to a fixed member;
a rotating bearing ring that is arranged so as to face the fixed bearing ring in a radial direction the rolling bearing and that is fixed to a rotating member;
a rolling element that is rollably arranged at a position between the fixed bearing ring and the rotating bearing ring in the radial direction; and
a seal member that seals up an annular space between the fixed bearing ring and the rotating bearing ring,
wherein an escape passage through which fluid is circulated in an axial direction of the rolling bearing so as to be allowed to escape is formed in a contact portion of the fixed bearing ring, which contacts the fixed member.

3. The rolling bearing device according to claim 1, wherein the seal member is a non-contact-type seal member which is fixed to the fixed bearing ring and with which a seal gap is formed between the seal member and the rotating baring ring.

4. The rolling bearing device according to claim 2, wherein the seal member is a non-contact-type seal member which is fixed to the fixed bearing ring and with which a seal gap is formed between the seal member and the rotating baring ring.

5. The rolling bearing device according to claim 1, wherein the escape passage is formed in a peripheral surface and an axial end surface of the fixed bearing ring.

6. The rolling bearing device according to claim 2, wherein the escape passage is formed in a peripheral surface and an axial end surface of the fixed bearing ring.

7. The rolling bearing device according to claim 3, wherein the escape passage is formed in a peripheral surface and an axial end surface of the fixed bearing ring.

8. The rolling bearing device according to claim 4, wherein the escape passage is formed in a peripheral surface and an axial end surface of the fixed bearing ring.

9. The rolling bearing device according to claim 1, wherein a plurality of the escape passages is formed at intervals in a circumferential direction of the rolling bearing.

10. The rolling bearing device according to claim 2, wherein a plurality of the escape passages is formed at intervals in a circumferential direction of the rolling bearing.

11. The rolling bearing device according to claim 3, wherein a plurality of the escape passages is formed at intervals in a circumferential direction of the rolling bearing.

12. The rolling bearing device according to claim 4, wherein a plurality of the escape passages is formed at intervals in a circumferential direction of the rolling bearing.

13. The rolling bearing device according to claim 5, wherein a plurality of the escape passages is formed at intervals in a circumferential direction of the rolling bearing.

14. The rolling bearing device according to claim 6, wherein a plurality of the escape passages is formed at intervals in a circumferential direction of the rolling bearing.

15. The rolling bearing device according to claim 7, wherein a plurality of the escape passages is formed at intervals in a circumferential direction of the rolling bearing.

16. The rolling bearing device according to claim 8, wherein a plurality of the escape passages is formed at intervals in a circumferential direction of the rolling bearing.

17. The rolling bearing device according to claim 5, wherein:
a plurality of the escape passages is formed at intervals in a circumferential direction of the rolling bearing; and
a communication groove that provides communication between the plurality of the escape passages formed in the peripheral surface of the fixed bearing ring and the plurality of the escape passages formed in the axial end surface of the fixed bearing ring is formed at a boundary portion between the peripheral surface and the axial end surface of the fixed bearing ring.

18. The rolling bearing device according to claim 6, wherein:
a plurality of the escape passages is formed at intervals in a circumferential direction of the rolling bearing; and
a communication groove that provides communication between the plurality of the escape passages formed in the peripheral surface of the fixed bearing ring and the plurality of the escape passages formed in the axial end surface of the fixed bearing ring is formed at a boundary portion between the peripheral surface and the axial end surface of the fixed bearing ring.

19. The rolling bearing device according to claim 7, wherein:
a plurality of the escape passages is formed at intervals in a circumferential direction of the rolling bearing; and
a communication groove that provides communication between the plurality of the escape passages formed in the peripheral surface of the fixed bearing ring and the plurality of the escape passages formed in the axial end surface of the fixed bearing ring is formed at a boundary portion between the peripheral surface and the axial end surface of the fixed bearing ring.

20. The rolling bearing device according to claim 8, wherein:
a plurality of the escape passages is formed at intervals in a circumferential direction of the rolling bearing; and
a communication groove that provides communication between the plurality of the escape passages formed in the peripheral surface of the fixed bearing ring and the plurality of the escape passages formed in the axial end surface of the fixed bearing ring is formed at a boundary portion between the peripheral surface and the axial end surface of the fixed bearing ring.
